(19) United States
(12) Patent Application Publication
(10) Pub. No.: US 2001/0043367 A1
(43) Pub. Date: Nov. 22, 2001

(54) Document reading device

(75) Inventor: Noboru Ogino, Tokyo (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Toshiba Tec Kabushiki Kaisha, Tokyo (JP)

(21) Appl. No.: 09/847,843

(22) Filed: May 1, 2001

(30) Foreign Application Priority Data
May 9, 2000 (JP) 2000-136098

(51) Int. Cl. H04N 1/40

(52) U.S. Cl. 358/449; 358/448

(57) ABSTRACT

A document reading device includes a reading unit for reading an image of a document, a document size detector for detecting a size of the document, and a controller for controlling the reading unit to read the image of the document in a read size corresponding to the document size confirmed from a detection result of the document size detector. Particularly, the controller includes an operation panel for inputting and outputting various information, and a CPU for requesting designation of a document size via the operation panel when the document size is not confirmable from a detection result of the document size detector and specifying the read size corresponding to the document size which is designated via the operation panel according to the request.

### CROSS-REFERENCE TO RELATED APPLICATIONS

This application is based upon and claims the benefit of priority from the prior Japanese Patent Application No. 2000-136098, filed May 9, 2000, the entire contents of which are incorporated herein by reference.

### BACKGROUND OF THE INVENTION

The present invention relates to a document reading device for reading an image of a document in a digital multiple apparatus which serves as a copying machine, a printer, a facsimile and the like.

Recently, a copying machine, a printer, and a facsimile are produced in the form of a digital multiple apparatus. The digital multiple apparatus generally includes a document size detector for detecting the size of a document placed on a document table at the time of a copying operation, so that recording sheets of a sheet size identical to the document size can be automatically selected from those of various sheet sizes, or copy magnification can be automatically set according to a difference between the document size and a sheet size when the sheet size has already been selected.

The document size detector is formed, for example, of reflection type optical sensors which are disposed at different fixed-size sensing points to receive reflected light from a document on the document table, and detects which one of the fixed sizes the document has, based on the presence or absence of the reflected light received by each optical sensor.

If a black portion of the document placed on the document table overlaps any of the sensing points of the optical sensors, the optical sensors cannot reliably sense the reflected light due to the low reflection coefficient of the black portion. Thus, it becomes difficult to detect the document size correctly.

As a solution to the problem described above, the conventional digital multiple apparatus is constructed to consider that the document is of a standard size when the document size is not confirmable from the detection result of the document size detector. When the actual document is of the standard size, the image of the document can be read appropriately. However, if the actual document is of a size lager than the standard size, the read image lacks part of the document image. As a result, the recording sheet is wastefully used to print a miscopy.

### BRIEF SUMMARY OF THE INVENTION

An object of the present invention is to provide a document reading apparatus which can prevent the image of a document from being read in a wrong read size.

According to the invention, a reading unit for reading an image of a document, a document size detector for detecting the size of the document, and a controller for controlling the reading unit to read the image of the document in a read size corresponding to the document size confirmed from a detection result of the document size detector, wherein the controller includes a user interface for inputting and outputting various information, and a read size specifying section for requesting designation of a document size via the user interface when the document size is not confirmable from a detection result of the document size detector and specifying the read size corresponding to the document size which is designated via the user interface according to the request.

In the document reading device, even if the document size is not confirmable from the detection result of the document size detector, the read size specifying section requests designation of the document size via the user interface and specifies the read size corresponding to the document size which is designated via the user interface according to the request. That is, the read size can be made suitable for the actual document size, and it is prevented that the reading unit reads the image of the document in a wrong read size.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the circuit structure of a digital multiple apparatus according to one embodiment of the invention;

FIG. 2 is a flowchart showing a document size setting process performed by the digital multiple apparatus shown in FIG. 1;

FIG. 3 is a flowchart showing a read control process performed by the digital multiple apparatus shown in FIG. 1; and

FIG. 4 is a view showing candidates of the document size displayed along with a request message of a document size designation on the display screen of the display unit shown in FIG. 1.

### DETAILED DESCRIPTION OF THE INVENTION

A digital multiple apparatus according to one embodiment of the invention will be described with reference to the accompanying drawings. The digital multiple device is constructed to serve as a copying machine, a printer, and a facsimile.

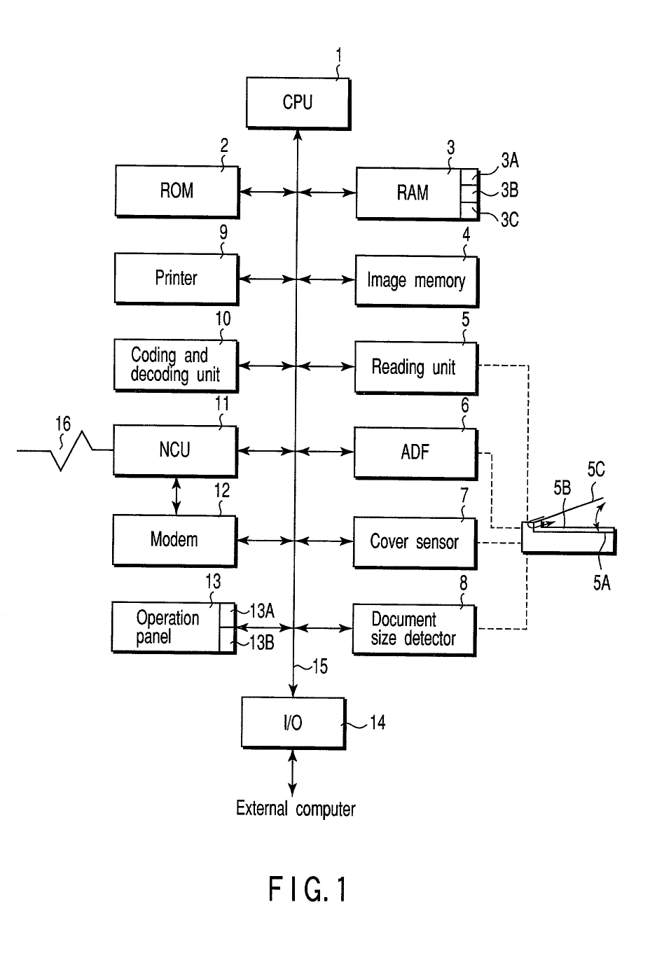

FIG. 1 shows the circuit structure of the digital multiple apparatus. The digital multiple apparatus includes a CPU 1 for controlling the overall operation of the apparatus, a ROM 2 storing fixed data such as a control program of the CPU 1, a RAM 3 for temporarily storing data input to and output from the CPU 1, an image memory 4 for temporarily storing image data, and a reading unit 5 for optically reading an image of a document in the manner conventionally known. The reading unit 5 has a transparent document table 5A for supporting a single document placed thereon, a platen cover 5B capable of being opened and closed with respect to the document table 5A to selectively cover the document, and a document tray 5C formed in one unit with the platen cover 5B for supporting a stack of documents placed thereon. The platen cover 5B is opened for allowing placement, displacement, and removal of the document made by a user, and closed for holding the document to maintain the position thereof.

The digital multiple apparatus further includes an Auto Document Feeder (ADF) 6, a cover sensor 7 for sensing open and closed states of the platen cover 5B, a document size detector 8 for detecting the size of the document placed on the document table 5A along with presence and absence thereof, and a printer 9 for printing an image on a recording sheet, coding and decoding unit 10 for performing compression cording of image data and decoding of compression coded image data, a Network Control Unit (NCU) 11 connected to a communication network 16 such as a Public Switched Telephone Network (PSTN), a modem 12 connected to the network control unit 11 to perform facsimile communication, an operation panel 13 serving as a user interface for inputting and outputting various information including information concerning the document size, an Input and Output interface (I/O) 14 connected to an external computer or the like, and a system bus 15 interconnecting the components 1-14.

The reading unit 5 optically reads an image of a stationary document on the document table 5A or an image of a document fed from the document tray 5C by the ADF 6, and converts the image into image data by means of an imaging process including a digitizing process. The reading unit 5 is capable of maintaining one document on the document table 5A while reading the image of another document fed by the ADF 6. The document size detector 8 is formed of reflection type optical sensors which are disposed at different fixed-size sensing points for fixed-sizes identical to the sizes of the recording sheets prepared in the printer 9 to receive reflected light from a document on the document table 5A, and detects which one of fixed sizes the document has, based on the presence or absence of the reflected light received by each optical sensor.

The NCU 11 performs an operation of calling and monitoring the state of the communication network 16 for facsimile communication and an operation of equalizing and level-matching facsimile transmission signals between the modem 12 and the communication network 16. The modem 12 modulates control data and image data to produce control and facsimile transmission signals to be transmitted to the communication network 16 via the NCU 11. The modem 12 further demodulates the control and facsimile transmission signals received from the communication network 16 via the NCU 11 to reproduce the control data and the image data. The operation panel 13 includes a key-in unit 13A to be operated by the user for designation of the document size, entry of a read start command, or the like, and a display unit 13B for displaying information such as a request message to the user. The key-in unit 13A has a transparent tablet overlaid on the display screen of the display unit 13B, for inputting key-in data when the user has touched a region corresponding to a key image displayed on the display screen.

The CPU1 performs a control process of controlling the components 2-14 by executing the control program stored in the ROM 2. The control process includes a copy mode, a printer mode, and a facsimile mode.

In the copy mode, the CPU 11 controls the reading unit 5 to read an image of the document on the document table 5A, stores in the image memory 4 copy-image data obtained as a result of reading, and controls the printer 9 to print an image corresponding to the copy-image data stored in the image memory 4. In the printer mode, the CPU 1 stores in the image memory 4 print-image data supplied from an external computer to the input output interface 14, and controls the printer 9 to print an image corresponding to the print-image data stored in the image memory 4. In the facsimile mode, the CPU 1 controls the reading unit 5 to read an image of the document for facsimile transmission, stores in the image memory 4 transmission-image data obtained as a result of reading, controls the coding and decoding unit 10 to perform a compression coding on the transmission-image data stored in the image memory 4, controls the modem 12 to convert the coded transmission-image data into a facsimile transmission signal to be transmitted to the communication network 16 via the NCU 11. Further, the CPU 1 controls the modem 12 to demodulate a facsimile transmission signal supplied from the communication network 16 via NCU 11 for facsimile reception, controls the coding and decoding unit 10 to perform a compression decoding on reception-image data obtained as a result of demodulation, stores the demodulated reception-image data in the image memory 4, and controls the printer 9 to print an image corresponding to this reception-image data stored in the image memory 4.

For example, in the copy mode, the document size detector 8 is used to attain an Auto Paper Select (APS) function of automatically selecting recording sheets of a sheet size identical to the document size from those of various sheet sizes prepared in the printer 9, and an Auto Magnification Select (AMS) function of automatically setting copy magnification according to a difference between the document size and a sheet size when the sheet size has already been selected by the operation panel 13. The operation panel 13 can be used for designating one of the APS and AMS functions in advance. With the APS or AMS function, the CPU 1 performs an operation of controlling the reading unit 5 to read an image of the document in a read size corresponding to a document size when the document size is confirmed from a detection result of the document size detector 8, and an operation of requesting designation of a document size at the display unit 13B when the document size is not confirmable from a detection result of the document size detector 8 and controlling the reading unit 5 to read the document in a read size corresponding to the document size which is designated at the key-in unit 13A according to the request. The RAM 3 has a memory area 3A for storing document size data representing the document size obtained as a detection result of the document size detector 8, a memory area 3B for storing document size designation data representing the document size designated at the key-in unit 13A for the document on the document table 5A, and a memory area 3C for storing feed document size data representing the document size designated at the key-in unit 13A for the document fed by the ADF 6.

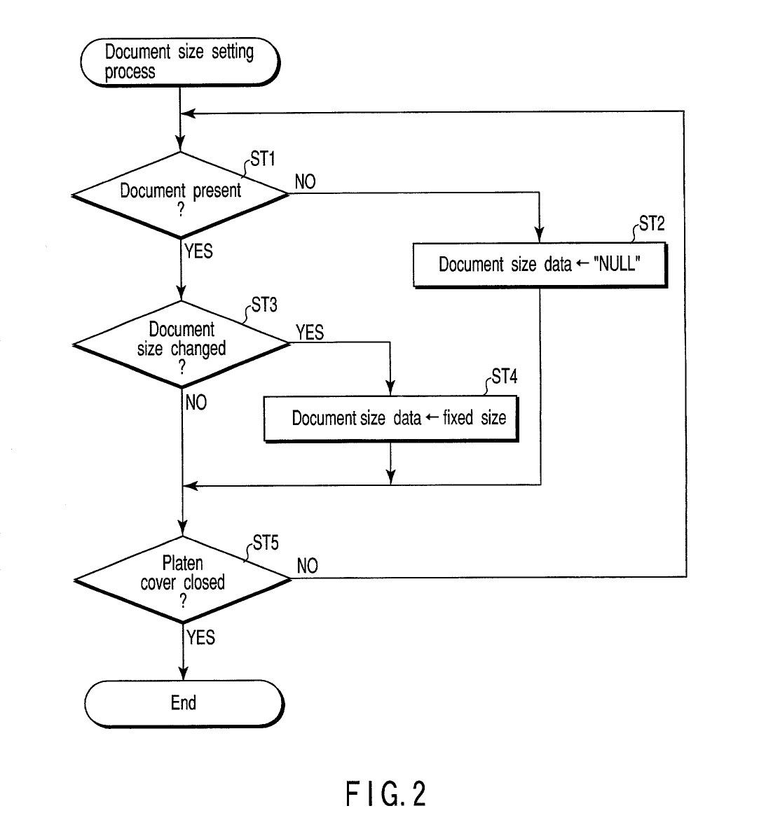

FIG. 2 shows a document size setting process for a document placed on the document table 5A in the copy mode. The setting process is performed when it is sensed by the cover sensor 7 that the platen cover 5B is changed from the closed state to the open state. When the setting process begins, the CPU 1 checks in step ST1 a detection result of the document size detector 8 to detect presence of the document on the document table 5A. When the presence of the document is not detected, the CPU 1 stores in step ST2 document size data of “NULL” representing an unknown size in the memory area 3A, and then executes step ST5. In addition, the document size data of “NULL” is also stored in the memory area 3A when the CPU 1 is unable to recognize the document size detector 8 connected to the system bus 15.

When the presence of the document is detected in step ST1, the CPU checks in step ST3 a detection result of the document size detector 8 to detect a variation from the document size represented by the document size data stored in the memory area 3A. When it is detected that the document size is changed to one of the fixed sizes, the CPU 1 updates in step ST4 the document size data in the memory area 3A to the fixed size, and then executes step ST5. When no difference of the document size is detected, step ST5 is executed after step ST3.

In step ST5, the CPU 1 checks a detection result of the cover sensor 7 to detect the closed state of the platen cover 5B. If the platen cover 5B is not in the closed state, steps ST1 to ST3 is repeated. Meanwhile, if placement, displacement, or removal of a document is made by the user, the document size data is updated in step ST2 or ST4 in a substantially real time-manner.

When the closed state of the platen cover 5B is detected in step ST5, the document size setting process is completed in a state where the memory area 3A stores the document size data reflecting the document size finally detected.

If no document is present on the document table 5A in the open state of the platen cover 5B, the document size data is set in step ST2 to “NULL” representing an unknown size. When the user has placed a document on the document table 5A, the document size detector 8 detects the presence and the size of the document. If a black portion of the document overlaps any of the sensing points of the optical sensors of the document size detector 8, the document size detector 8 outputs an unknown size detection result, indicating that the document is not of any of the fixed sizes. In this case, since change of the document size is not detected in step ST3, step ST5 is executed without updating of the document size data. If displacement or replacement of the document is carried out before closing the platen cover 5B, the document size data “NULL” is fixedly set when the platen cover 5B has been closed.

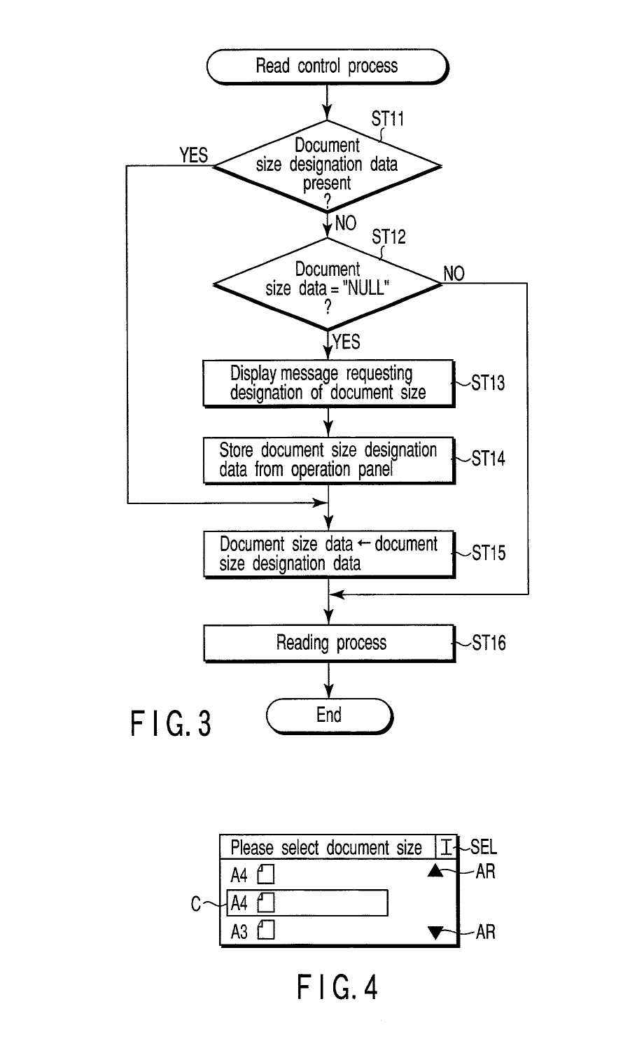

FIG. 3 shows a read control process for a control of reading an image of the document placed on the document table 5A in the copy mode. The read control process is performed in response to the read start command which is input from the operation panel 13 after the document size setting process. When the read control process begins, the CPU 1 checks in step ST11 whether the document size designation data is already stored in the memory area 3B to designate the document size required when the APS or AMS function is not used. When the document size designation data is not present, the CPU 1 checks in step 12 whether the document size data in the memory area 3A is of “NULL”.

When the document size data is of “NULL”, the document on the document table 5A is of an unknown size. Thus, the CPU 1 controls the display unit 13B in step ST13 to display a message for requesting that the user designate the document size, along with candidates of the document size as shown in FIG. 4. Then, the CPU 1 stores in step ST14 the document size designated at the key-in unit 13A operated by the user according to the request in the memory area 3B as the document designation data. The designation of the document size can be made by operating arrow keys AR to move a cursor C on the display screen of the display unit 13B and operating a select key SEL to select the candidate of the document size located at the position of the cursor C.

The CPU 1 executes step ST15 after step ST14. Step ST15 is also executed when it is detected in step ST11 that the document size designation data is already stored in the memory area 3B. In step ST15, the CPU 1 updates the document size data in the memory area 3A by using the document size designation data in the memory area 3B. Thereafter, the CPU 1 controls the reading unit in step ST16 5 to perform a reading process of reading an image of the document in a read size corresponding to the document size represented by the document size data in the memory 3A, and storing in the image memory 4 copy-image data obtained as a result of reading. Step ST16 is also executed when it is detected in step ST12 that the document size data is not of “NULL”.

The read control process is completed after the copy-image data is stored in the image memory 4 in step ST16. The printer 9 prints an image corresponding to the copy-image data stored in the image memory 4 as a reading result of the reading unit 5.

According to the embodiment described above, when the document size detector 8 fails to detect the document size, it becomes difficult to confirm the document size from a detection result of the document size detector 8. In a case where the APS function, the AMS function, or the like is used, the read start command is input without to start the read control process designating the document size after the document size setting process. In this case, the CPU 1 requests at the display unit 13B that the user designate the document size, and specifies a read size corresponding to the document size designated by the user at the key-in unit 13A according to the request. Since the read size is made suitable for the actual document size, the reading unit 5 can be prevented from reading an image of the document in a wrong read size. Further, the printer 9 has a plurality of sheet cassettes each for storing the recording sheets as in the conventional manner. When one of the cassettes becomes empty during the copying operation, this cassette is changed to another one storing recording sheets of the same size. Since the user is requested to designate the document size when the document size is not confirmable from a detection result of the document size detector 8, there is no need to recognize the contents of the sheet cassettes of the printer 9.

According to the embodiment, the document size setting process is performed when the platen cover 5B is opened. The document size data can be cleared to “NULL” representing an unknown size only in the document size setting process. The read control process begins in the closed state of the platen cover 5B. When the user designates the document size at the key-in unit 13A in the read control process, the document size data thus set by the designation is maintained until the platen cover 5B is opened again. For example, in a case where an interrupt process is performed for printing an image corresponding to the reception-image data obtained by facsimile communication, it is not necessary that the platen cover 5 is opened in the interrupt process. Thus, the existing document size data is usable for specifying the read size of the document to resume the copying operation interrupted by the interrupt process. Accordingly, if the platen cover 5B is not opened, it is unnecessary that the document size is designated again to read an image of the document on the document table 5B, thus reducing the load on the user.

In the embodiment, even if the document is present on the document table 5A, the reading unit 5 is able to read an image of another document fed from the document tray 5C by the ADF 6. In this case, the feed document size data in the memory area 3C is used to specify the read size of the fed document. That is, the document size data in the memory area 3A is not updated by performing an interrupt process of reading the document fed by the ADF 6. Therefore, the document size data in the memory area 3A is usable for specifying the read size of the document on the document table 5A to resume the copying operation interrupted by the interrupt process. Accordingly, if the platen cover 5B is not opened, it is unnecessary that the document size is designated again to read an image of the document on the document table 5B, thus reducing the load on the user.

In the embodiment, the document size data of “NULL” is stored in the memory area 3A when the CPU 1 is unable to recognize the document size detector 8 connected to the system bus 15. Therefore, even if the document size detector 8 is eliminated to reduce the manufacturing cost, malfunctioning of the digital multiple apparatus can be prevented. As a result, a cheep digital multiple apparatus which does not have the APS and AMS functions can be added to the product lineup without requiring any modification of the software such as the control program of the CPU 1.

Further, in the embodiment, the document reading device is incorporated in the digital multiple apparatus. However, the document reading device may be incorporated in an image processing apparatus such as a facsimile, copying machine, or the like, and may be produced as an individual device only for reading an image of the document and converting the image into image data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document reading device comprising:
a reading unit for reading an image of a document;
a document size detector for detecting a size of the document; and
a controller for controlling said reading unit to read the image of the document in a read size corresponding to the document size confirmed from a detection result of said document size detector;
wherein said controller includes a user interface for inputting and outputting various information, and read size specifying means for requesting designation of a document size via said user interface when the document size is not confirmable from a detection result of the document size detector and specifying the read size corresponding to the document size which is designated via said user interface according to the request.

2. A document reading device according to claim 1, wherein said reading unit includes a document table for supporting a single document placed thereon and a cover capable of being opened and closed, and said read size specifying means is constructed such that the document size designated via said user interface is confirmed in a state where said cover is closed, and the document size is maintained until said cover is opened.

3. A document reading device according to claim 2, wherein:
the document reading device further comprises a document feeder for feeding a document other than the document on said document table;
said reading unit is capable of reading an image of the other document fed by the document feeder while maintaining the document on the document table 5A; and said read size specifying means is constructed such that the read size for the document fed by the document feeder is independently specified from the read size for the document on said document table to maintain the document size designated for the document on the document table until the cover is opened.
